(19) United States
(12) Patent Application Publication
(10) Pub. No.: US 2015/0353053 A1
(43) Pub. Date: Dec. 10, 2015

(54) DEVICE FOR AIR-CONDITIONING A VEHICLE COMPRISING A DEFROSTING PIPE NETWORK

(71) Applicant: RENAULT, Boulogne Billancourt (FR)

(72) Inventors: Pascal PENCOLE, Plaisir (FR); Karine LOYER, Mere (FR)

(73) Assignee: RENAULT S.A.S., Boulogne Billancourt (FR)

(21) Appl. No.: 14/758,925

(22) PCT Filed: Mar. 3, 2014
(86) PCT No.: PCT/FR14/50457

§ 371 Date: Jul. 1, 2015

(30) Foreign Application Priority Data
Mar. 4, 2013 (FR) 1351881

(51) Int. Cl. B60S 1/02; B60S 1/54

(52) U.S. Cl. CPC B60S 1/023; B60S 1/54

(57) ABSTRACT

A vehicle air-conditioning device, including: a defrosting pipe network which includes; a duct for defrosting an air-conditioning apparatus, a first duct connected to the defrosting duct and corresponding to a windshield defrosting strip, a second duct connected to the defrosting duct and corresponding to two side defrosting vents. The defrosting duct includes three different adjacent openings of two side openings and a central opening. The central opening is connected to an inlet of the second duct and located to a rear of the side openings along the longitudinal direction of the vehicle. The first duct includes two different inlets, each respectively connected to a side opening.

The invention relates to an air-conditioning device for a vehicle including a network of defrosting pipes.

It relates in particular to an air-conditioning device including a defrosting pipe network which comprises:
a defrosting duct of an air-conditioning apparatus intended to supply defrosting air,
a first duct connected to the defrosting duct and intended to correspond with a grille for defrosting the windshield, and
a second duct connected to the defrosting duct and intended to correspond with two lateral defrosting vents of the vehicle.

In the case of certain vehicles that are equipped with a device of this type, the first duct is connected to the centre of an opening in the defrosting duct, the second duct taking the air on the sides of the same opening in the defrosting duct to either side of the first duct. This opening is generally located at the end of the defrosting duct.

In order to improve the distribution of the air between the first and second ducts, the arrangement of the ducts has been modified in such a way that the second duct takes the air at the centre of the opening in the defrosting duct, the first duct taking the air on the sides of the same opening in the defrosting duct to either side of the second duct.

An arrangement of this type is described in document FR 2 876 958 A1 and permits an improvement in the rates of flow inside the ducts. In this document, the second duct consists of a first section connected to the central part of the opening in the defrosting duct, and a second section including two channels, the inlet of each channel being connected to the first section, and the outlet of each channel being adapted to correspond with a lateral defrosting vent. Due to restrictions on the size of the zone located behind the opening in the air-conditioning device in the longitudinal direction of the vehicle, these channels are located ahead of the opening in the defrosting duct, in other words between this opening and the windshield.

As a result of the presence of these channels, the dashboard zone located ahead of the opening in the air-conditioning duct exhibits a certain rigidity, which may be detrimental to a pedestrian in the event of a pedestrian impact. Repositioning the channels towards the rear of the opening in the defrosting duct would, in addition, involve load losses inside the duct as a result of the formation of a quite pronounced, rearward-facing elbow, the opening in the defrosting duct in effect being inclined from bottom to top in the direction of the windshield. Moreover, such a tortuous shape of the channels is susceptible to generating high noise levels.

The invention intends to address these disadvantages by proposing an air-conditioning device for a vehicle which enables the requirements in respect of pedestrian impact to be satisfied for the dashboard, and in particular without compromising the aeraulic and acoustic performance of the network of pipes.

For this purpose, the subject of the invention relates to an air-conditioning device intended to be installed in a vehicle, said air-conditioning device including a defrosting pipe network which comprises:
a defrosting duct of an air-conditioning apparatus intended to supply defrosting air,
a first duct connected to the defrosting duct and intended to correspond with a grille for defrosting the windshield of the vehicle, and
a second duct connected to the defrosting duct and intended to correspond with two lateral defrosting vents of the vehicle,

characterized in that the defrosting duct comprises three distinct adjacent openings, these being two lateral openings and one central opening, said central opening being connected to an inlet of the second duct and being located to the rear of said lateral openings in the longitudinal direction of the vehicle when the air-conditioning device is installed in said vehicle, and in that said first duct comprises two distinct inlets, each connected respectively to a lateral opening.

This arrangement makes it possible to maintain a good distribution of the rates of flow between the defrosting of the windshield and of the side windows, while freeing the dashboard space located between the defrosting duct of the air-conditioning device and the windshield of all pipework, in accordance with the requirements in respect of pedestrian impact.

In particular, the second duct comprises a single inlet connected to the central opening.

The lateral and central openings of the defrosting duct are preferably located at the end of a duct of the air-conditioning apparatus, referred to as the defrosting duct.

Advantageously and in a non-restrictive manner, the inlet of the second duct may be located at the centre or substantially at the centre of said second duct in a longitudinal direction thereof.

Advantageously and in a non-restrictive manner, the second duct may comprise:
a straight or substantially straight central section comprising the inlet of the second duct, and
two lateral sections, each connected to an end of the central section, a free end of each lateral section forming an outlet of the second duct adapted to correspond with a lateral defrosting vent of the vehicle.

The second duct then exhibits a substantially straight shape, which may permit the load losses to be limited and the generation of noise to be reduced. For example, the second duct may be substantially straight or straight over at least half of its total length, or over at least 60% or 70% of its total length.

This arrangement may also make it possible to simplify the production of the air-conditioning device by simplifying the shape of the second duct.

Advantageously and in a non-restrictive manner, the inlet of said second duct may then be located at the centre of the central section.

Advantageously and in a non-restrictive manner, the inlet of said second duct may comprise an air guide arranged in such a way as to divide said inlet into two parts, these being a first part communicating with a first outlet adapted to correspond with a lateral defrosting vent of the vehicle and a second part communicating with a second outlet adapted to correspond with another lateral defrosting vent of the vehicle.

This air guide may be a wall that is transverse to the longitudinal direction of the second duct, parallel to the direction of the incoming air flow.

Advantageously and in a non-restrictive manner, in the interests of the better distribution of the air in the direction of the windshield, the lateral openings may be adjacent elongated openings, of which the longitudinal axes are combined, said lateral openings being so arranged as to extend substantially parallel to a transverse direction of the vehicle when the air-conditioning device is installed in the vehicle. In other words, the two lateral openings extend substantially as an extension of each other in the transverse direction of the vehicle.

Another subject of the invention is a vehicle comprising a dashboard provided with a grille for defrosting the windshield and with lateral vents for defrosting the side windows, and an air-conditioning device according to the invention. The openings in the defrosting duct then discharge beneath the dashboard, substantially in the middle thereof, in the transverse direction of the vehicle. In particular, the central opening may be located on the longitudinal axis of the vehicle.

The invention will now be described with reference to the accompanying non-restrictive drawings, in which:

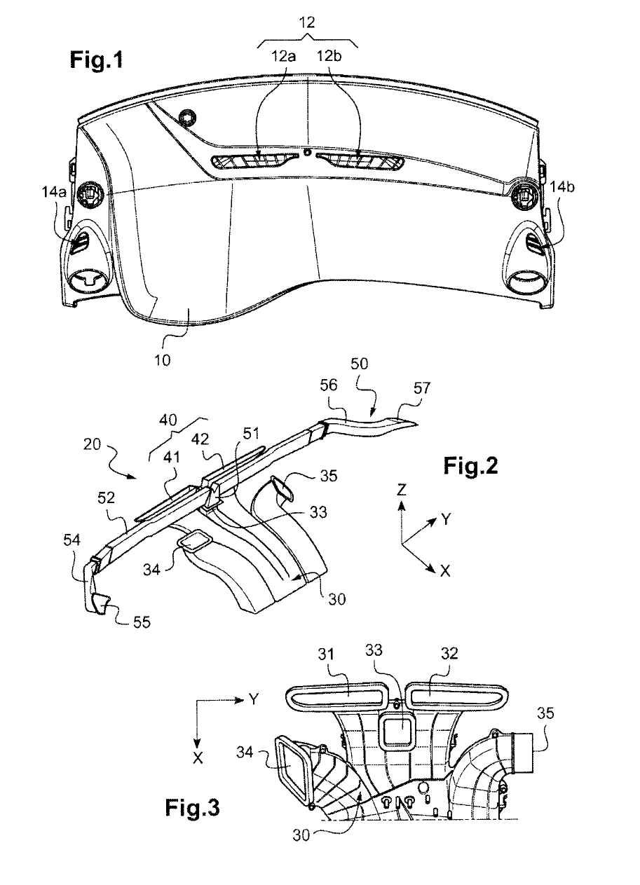

FIG. 1 is a view from above of a vehicle dashboard adapted to receive an air-conditioning device according to one embodiment of the invention;

FIG. 2 is a view in perspective of a network of pipes according to one embodiment of the invention;

FIG. 3 depicts a defrosting duct of the network of pipes depicted in FIG. 2;

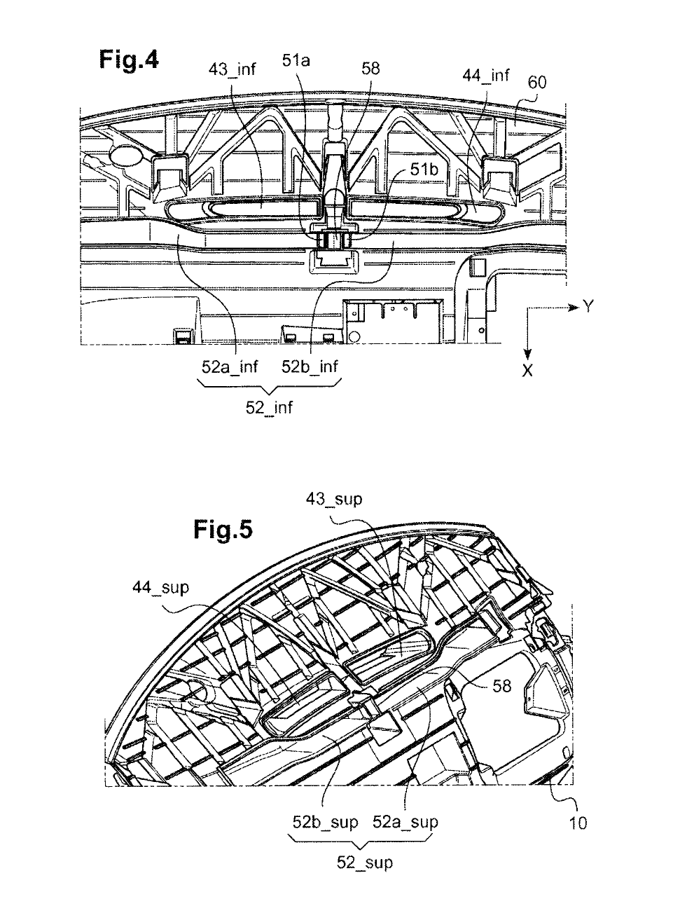

FIG. 4 is a view from above of a reinforcement for the dashboard in FIG. 1;

FIG. 5 is a view from below of the dashboard depicted in FIG. 1.

In the present description, the terms front, rear, upper, lower refer to the front and rear directions of the vehicle, when the air-conditioning device is installed in the vehicle. The axes X, Y, Z correspond respectively to the longitudinal (from front to rear), transverse and vertical axes of the vehicle.

FIGS. 1 and 5 depict a dashboard 10 of a vehicle, provided with a grille 12 for defrosting the windshield and lateral vents 14a, 14b for defrosting the side windows. The defrosting grille 12 comprises two orifices 12a and 12b.

The dashboard 10 is adapted to receive an air-conditioning device according to the invention. In particular, this air-conditioning device includes a network 20 of defrosting pipes as depicted in FIG. 4.

This network 20 of defrosting pipes comprises:
a defrosting duct 30 of an air-conditioning apparatus (not depicted here), intended to supply defrosting air,
a first duct 40 connected to the defrosting duct 30 and intended to correspond with the defrosting grille 12 for the windshield of the vehicle, and
a second duct 50 connected to the defrosting duct 30 and intended to correspond with the two lateral defrosting vents 14a, 14b of the vehicle.

According to the invention, the defrosting duct 30 comprises three distinct adjacent openings 31, 32, 33, these being two lateral openings 31, 32 and one central opening 33, as can be seen in FIG. 3. These lateral 31, 32 and central 33 openings of the defrosting duct 30 are located at an end of this defrosting duct 30. The latter may also comprise other openings 34, 35 (FIGS. 2 and 3), for example for the air-conditioning of the passenger compartment of the vehicle.

The central opening 33 is connected to an inlet 51 of the second duct 50. This central opening 33 is located to the rear of the lateral openings 31, 32 of the defrosting duct in the longitudinal direction X of the vehicle when the air-conditioning device is installed in said vehicle.

The first duct 40 comprises two distinct inlets 41, 42, each connected respectively to a lateral opening 31, 32.

As can be seen in FIG. 2, the second duct 50 comprises a single inlet 51 connected to the central opening 33 of the defrosting duct 30. This inlet 51 is located at the centre or substantially at the centre of the second duct 50 in a longitudinal direction thereof. When the device according to the invention is installed in the vehicle, this inlet is located on or substantially on the longitudinal axis X of the vehicle.

In the depicted example, the second duct 50 comprises:
a straight or substantially straight central section 52 comprising the inlet 51 of the second duct, and
two lateral sections 54, 56, each connected to an end of the central section 52, a free end 55, 57 of each lateral section 54, 56 respectively forming an outlet of the second duct adapted respectively to correspond with a lateral defrosting vent 14a, 14b of the vehicle.

The second duct 50 thus exhibits an essentially straight shape, in other words a straight shape over at least half of its total length, or over at least 60% or 70% of its total length.

The network 20 of pipes may be formed in part in the dashboard 10 itself and in part in a dashboard reinforcement 60 intended to be arranged beneath the dashboard 10. In particular, the first and second ducts may be defined in their upper part by the dashboard 10 and in their lower part by the dashboard reinforcement 60, as in the case of the example depicted in FIGS. 4 and 5.

The reinforcement 60 thus comprises on its face intended to be applied beneath the dashboard 10 (the face visible in FIG. 4) the lower part 52_inf of the central section 52 of the second duct 50, whereas the lower face of the dashboard 10 (face visible in FIG. 5) comprises the upper part 52_sup of the same central section 52. Each part 52_sup and 52_inf is separated into two 52a_sup, 52b_sup and 52a_inf, 52b_inf, respectively by an air guide 58 arranged in such a way as to divide the inlet 51 into two parts 51a, 52b (FIG. 4). The first part 51a communicates with a first outlet 55 adapted to correspond with a lateral defrosting vent 14a of the vehicle, and a second part 51b communicating with the second outlet 57 adapted to correspond with the other lateral defrosting vent 14b of the vehicle.

This air guide 58 may be a wall that is transverse to the longitudinal direction of the second duct, parallel to the direction of the incoming air flow.

The secondary sections 54 and 56 of the second duct for their part form distinct ducts, each of which is connected to the central section 52 and to the outlets 55 and 57 respectively.

The first duct 40 depicted in the figures consists of two distinct ducts, of which the lower part 43_inf, 44_inf is part of the dashboard reinforcement 60, and the upper part 43_sup, 44_sup, respectively, is part of the dashboard 10. Each of these ducts connects a lateral opening 31, 32 to a respective orifice 12a, 12b of the grille 12.

The lateral openings 31, 32 are adjacent elongated openings, of which the longitudinal axes are combined, said lateral openings 31, 32 being so arranged as to extend substantially parallel to a transverse direction Y of the vehicle when the air-conditioning device is installed in the vehicle. These lateral openings 31, 32 in fact possess a shape that is similar to the shape of the orifices 12a, 12b of the grille 12.

The openings 31 to 33 of the defrosting duct 30 of the air-conditioning apparatus thus discharge beneath the dashboard 10, substantially at the centre thereof, in the transverse direction of the vehicle. In particular, the central opening 33 is located on the longitudinal axis X of the vehicle. The central openings 31 and 32, for their part, discharge substantially beneath the orifices 12a, 12b respectively of the dashboard 10.

1-7. (canceled)

8. An air-conditioning device configured to be installed in a vehicle, the air-conditioning device comprising a defrosting pipe network which comprises:
a defrosting duct of an air-conditioning apparatus configured to supply defrosting air;
a first duct connected to the defrosting duct and configured to correspond with a grill for defrosting a windshield of the vehicle; and
a second duct connected to the defrosting duct and configured to correspond with two lateral defrosting vents of the vehicle;
wherein the defrosting duct comprises three distinct adjacent openings of two lateral openings and one central opening, the central opening being connected to an inlet of the second duct and being located to a rear of the lateral vents in the longitudinal direction of the vehicle when the air-conditioning device is installed in the vehicle, and
wherein the first duct comprises two distinct inlets, each connected respectively to a lateral opening.

9. The air-conditioning device as claimed in claim 8, wherein the inlet of the second duct is located at a center or substantially at a center of the second duct in a longitudinal direction thereof.

10. The air-conditioning device as claimed in claim 8, wherein the second duct comprises:
a straight or substantially straight central section comprising the inlet of the second duct, and
two lateral sections, each connected to an end of the central section, a free end of each lateral section forming an outlet of the second duct configured to correspond with a lateral defrosting vent of the vehicle.

11. The air-conditioning device as claimed in claim 10, wherein the inlet of the second duct is located at the center of the central section.

12. The air-conditioning device as claimed in claim 8, wherein the inlet of the second duct comprises an air guide configured to divide the inlet into two parts of a first part communicating with a first outlet configured to correspond with a lateral defrosting vent of the vehicle and a second part communicating with a second outlet configured to correspond with another lateral defrosting vent of the vehicle.

13. The air-conditioning device as claimed in claim 8, wherein the lateral openings are adjacent elongated openings, of which the longitudinal axes are combined, the lateral openings configured to extend substantially parallel to a transverse direction of the vehicle when the air-conditioning device is installed in the vehicle.

14. A vehicle comprising:
a dashboard comprising a grill for defrosting a windshield and comprising lateral vents for defrosting side windows; and
an air-conditioning device as claimed in claim 8, openings in the defrosting duct discharging beneath the dashboard, substantially in a middle of the dashboard in the transverse direction of the vehicle.
